(19) United States
(12) Patent Application Publication
(10) Pub. No.: US 2026/0366328 A1
(43) Pub. Date: Nov. 19, 2026

(54) HANDLE ASSEMBLY

(71) Applicant: PRIMAX ELECTRONICS LTD., Taipei City (TW)

(72) Inventors: HSING-FANG YEH, Taipei City (TW); YUNG-MING TSAI, Taipei City (TW); LI-CHUN WANG, Taipei City (TW)

(21) Appl. No.: 19/240,014

(22) Filed: Jun. 17, 2025

(30) Foreign Application Priority Data
May 16, 2025 (TW) 114118436

(51) Int. Cl. E05B 3/04; E05B 1/00

(52) U.S. Cl. CPC E05B 3/04; E05B 1/003

(57) ABSTRACT

A handle assembly includes a handle, a handle shaft and an elastic member. An end of the handle has a recess provided with two guide protrusions opposite to each other therein. The handle shaft corresponds to the recess of the end of the handle and has two guide grooves opposite to each other. The two guide protrusions are able to move in the two guide grooves, respectively. Each of the two guide grooves has fitting, rotation and engagement regions. The rotation region is connected between the fitting region and the engagement region. The handle shaft is provided with an abutment portion adjacent to each of the rotation regions. The elastic member is adjacent to the abutment portion of the handle shaft and is configured to be compressed by the end of the handle and to return to push against the end of the handle.

### FIELD OF THE INVENTION

The present invention relates to a handle assembly that can be quickly switched.

### BACKGROUND OF THE INVENTION

Handle assemblies currently on the market usually fix the handle with screws or hook structures. If the handle needs to be switched in direction, additional tools are required to disassemble the handle. Such handles usually have screws or holes on the appearance thereof.

### SUMMARY OF THE INVENTION

The present invention provides a handle assembly, which includes a handle, a handle shaft and an elastic member. An end of the handle has a recess provided with two guide protrusions opposite to each other therein. The handle shaft corresponds to the recess of the end of the handle and has two guide grooves opposite to each other. The two guide protrusions are able to move in the two guide grooves, respectively, in which each of the two guide grooves has a fitting region, a rotation region and an engagement region, and the rotation region is connected between the fitting region and the engagement region, and the handle shaft is provided with an abutment portion adjacent to each of the rotation regions. The elastic member is adjacent to the abutment portion of the handle shaft and is configured to be compressed by the end of the handle and to return to push against the end of the handle.

In some embodiments of the present invention, after each of the guide protrusions enters the fitting region of one of the two guide grooves of the handle shaft, the end of the handle is able to compress the elastic member.

In some embodiments of the present invention, after the end of the handle compresses the elastic member, each of the guide protrusions is able to enter the rotation region of one of the two guide grooves of the handle shaft.

In some embodiments of the present invention, after each of the guide protrusions enters the rotation region of the one of the two guide grooves of the handle shaft and the end of the handle is rotated, the elastic member is able to return to push against the end of the handle so that each of the guide protrusions enters the engagement region of the one of the two guide grooves.

In some embodiments of the present invention, the abutment portion extends radially outwardly along the handle shaft.

In some embodiments of the present invention, the rotation region is arranged along a circumferential direction of the handle shaft.

In some embodiments of the present invention, the fitting region and the engagement region extend axially along the handle shaft.

In some embodiments of the present invention, an axial length of the fitting region is greater than an axial length of the engagement region.

In some embodiments of the present invention, a width of the fitting region is substantially the same as a width of the engagement region.

In some embodiments of the present invention, the elastic member surrounds the handle shaft.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a schematic diagram of an appearance of a handle assembly according to an embodiment of the present invention.

FIG. 2 is a three-dimensional schematic diagram of a handle according to an embodiment of the present invention.

FIG. 3 is a three-dimensional schematic diagram of a handle shaft and an elastic member according to an embodiment of the present invention.

FIG. 4 is a three-dimensional schematic diagram of a handle shaft according to an embodiment of the present invention.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, handle assemblies currently on the market usually fix the handle with screws or hook structures. If the handle needs to be switched in direction, additional tools are required to disassemble the handle. Such handles usually have screws or holes on the appearance thereof. Accordingly, the present invention provides a handle assembly, which includes a handle, a handle shaft and an elastic member, in which two guide protrusions opposite to each other are provided in a recess of an end of the handle, and the handle shaft has two guide grooves opposite to each other, and the two guide protrusions are able to move in the two guide grooves, respectively. An installation method of the handle of the present invention has following steps. The recess of the end of the handle is sleeved onto the handle shaft, so that the end of the handle compresses the elastic member, and the handle is then rotated to rotate the end of the handle, and the elastic member returns to make the end of the handle engage with the handle shaft. In this way, the installation and switch in direction of the handle do not require the use of additional tools, and the handle has functions such as quick installation and quick switch in direction, and there are no screws or holes on the appearance of the handle, so the handle assembly has a more aesthetically pleasing appearance. Various embodiments of the handle assembly of the present invention will be described in detail below.

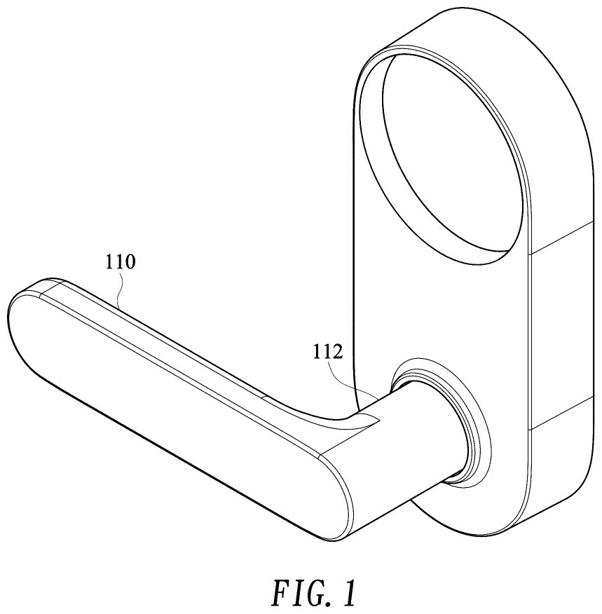

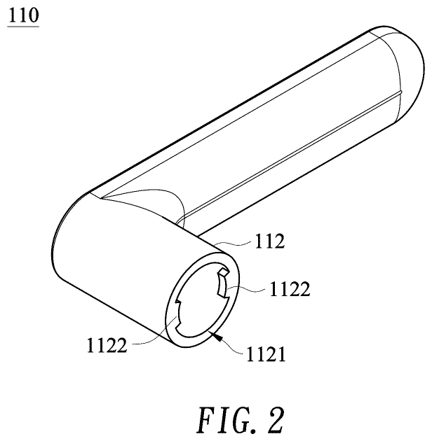

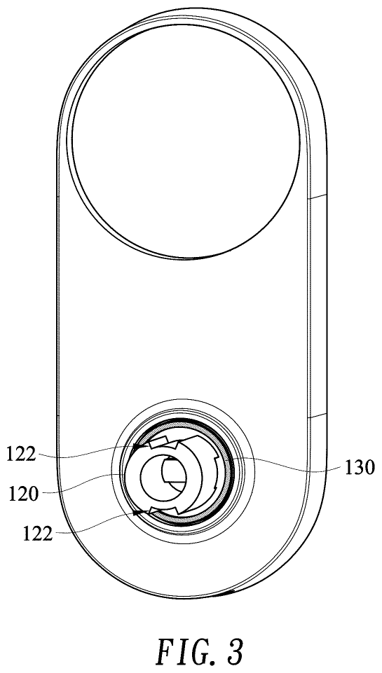

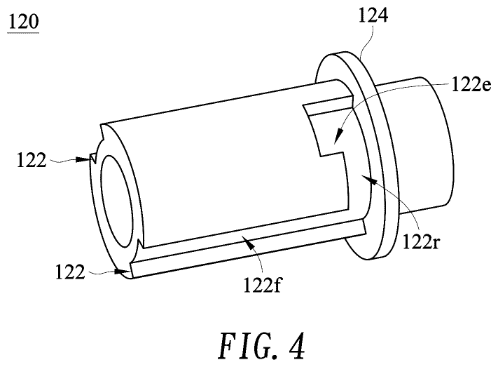

FIG. 1 is a schematic diagram of an appearance of a handle assembly according to an embodiment of the present invention. FIG. 2 is a three-dimensional schematic diagram of a handle according to an embodiment of the present invention. FIG. 3 is a three-dimensional schematic diagram of a handle shaft and an elastic member according to an embodiment of the present invention. FIG. 4 is a three-dimensional schematic diagram of a handle shaft according to an embodiment of the present invention. As shown in FIGS. 1 to 4, the handle assembly includes a handle 110, a handle shaft 120, and an elastic member 130.

As shown in FIG. 2, the end 112 of the handle 110 has a recess 1121. The recess 1121 is provided with two guide protrusions 1122 opposite to each other therein.

As shown in FIGS. 2 and 3, the handle shaft 120 corresponds to the recess 1121 of the end 112 of the handle 110, and has two guide grooves 122 opposite to each other, and the two guide protrusions 1122 are able to move in the two guide grooves 122, respectively. In some embodiments, as shown in FIG. 2, the guide protrusion 1122 is an arc-shaped protrusion. However, the present invention is not limited to the aforementioned embodiments, and the guide protrusion can be of other shapes as long as it can move in the guide groove 122.

As shown in FIG. 4, each of the guide grooves 122 of the handle shaft 120 has a fitting region 122f, a rotation region 122r and an engagement region 122e, and the rotation region 122r is connected between the fitting region 122f and the engagement region 122e. In some embodiments, the fitting region 122f and the engagement region 122e extend axially along the handle shaft 120. In some embodiments, the rotation region 122r is arranged along a circumferential direction of the handle shaft 120. In some embodiments, an axial length of the fitting region 122f is greater than an axial length of the engagement region 122e. In some embodiments, a width of the fitting region 122f is substantially the same as a width of the engagement region 122e. In some embodiments, referring to FIGS. 2 and 4, a thickness of the guide protrusion 1122 is less than an axial length of the rotation region 122r.

As shown in FIG. 4, the handle shaft 120 is provided with an abutment portion 124 adjacent to each of the rotation regions 122r. In some embodiments, the abutment portion 124 extends radially outwardly along the handle shaft 120.

As shown in FIGS. 3 and 4, the elastic member 130 is adjacent to the abutment portion 124 of the handle shaft 120 and is configured to be compressed by the end 112 of the handle 110 and to return to push against the end 112 of the handle 110. In some embodiments, the elastic member 130 surrounds the handle shaft 120. The elastic member 130 may be fixed or not fixed to the abutment portion 124.

The following describes an installation method of the handle of the present invention. Referring to FIGS. 2 to 4, when the recess 1121 of the end 112 of the handle 110 is sleeved onto the handle shaft 120 and each of the guide protrusions 1122 enters the fitting region 122f of one of the two guide grooves 122 of the handle shaft 120, the end 112 of the handle 110 can compress the elastic member 130. After the end 112 of the handle 110 compresses the elastic member 130, each of the guide protrusions 1122 can enter the rotation region 122r of the one of the two guide grooves 122 of the handle shaft 120. After each of the guide protrusions 1122 enters the rotation region 122r of the one of the two guide grooves 122 of the handle shaft 120, and the end 112 of the handle 110 is rotated (e.g., rotated counterclockwise), the elastic member 130 can return to push against the end 112 of the handle 110, so that each of the guide protrusions 1122 enters the engagement region 122e of the one of the two guide grooves 122, so that the end 112 of the handle 110 is engaged with the handle shaft 120.

The following describes a handle-direction switching method of the present invention. Please refer to FIGS. 1 to 4, first, the end 112 of the handle 110 compresses the elastic member 130, so that the guide protrusion 1122 enters the rotation region 122r from the engagement region 122e, and the end 112 of the handle 110 is then rotated (e.g., rotated clockwise) so that the elastic member 130 can return to push against the end 112 of the handle, so that the guide protrusion 1122 enters the fitting region 122f, and the handle 110 can be removed from the handle shaft 120. After the handle 110 is turned, the handle 110 can be installed according to the above installation method.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

1. A handle assembly, comprising:
a handle, wherein an end of the handle has a recess provided with two guide protrusions opposite to each other therein;
a handle shaft, corresponding to the recess of the end of the handle, and having two guide grooves opposite to each other, the two guide protrusions being able to move in the two guide grooves, respectively, wherein each of the two guide grooves has a fitting region, a rotation region and an engagement region, and the fitting region and the engagement region extend axially along the handle shaft, and an axial length of the fitting region is greater than an axial length of the engagement region, and the rotation region is arranged along a circumferential direction of the handle shaft, and the rotation region is connected between the fitting region and the engagement region, and the handle shaft is provided with an abutment portion adjacent to each of the rotation regions; and
an elastic member, surrounding the handle shaft and adjacent to the abutment portion of the handle shaft, and configured to be compressed axially by the end of the handle along an axis of the elastic member and to return axially along the axis of the elastic member to push against the end of the handle.

2. A handle assembly of claim 1, wherein after each of the guide protrusions enters the fitting region of one of the two guide grooves of the handle shaft, the end of the handle is able to axially compress the elastic member along the axis of the elastic member.

3. A handle assembly of claim 1, wherein after the end of the handle axially compresses the elastic member along the axis of the elastic member, each of the guide protrusions is able to enter the rotation region of one of the two guide grooves of the handle shaft.

4. A handle assembly of claim 3, wherein after each of the guide protrusions enters the rotation region of the one of the two guide grooves of the handle shaft and the end of the handle is rotated, the elastic member is able to axially return along the axis of the elastic member to push against the end of the handle so that each of the guide protrusions enters the engagement region of the one of the two guide grooves.

5. A handle assembly of claim 1, wherein the abutment portion extends radially outwardly along the handle shaft.

6. (canceled)

7. (canceled)

8. (canceled)

9. The handle assembly of claim 1, wherein a width of the fitting region is substantially the same as a width of the engagement region.

10. (canceled)

11. The handle assembly of claim 1, wherein a thickness of the guide protrusion is less than an axial length of the rotation region.
